(19) United States
(12) Patent Application Publication
(10) Pub. No.: US 2021/0342371 A1
(43) Pub. Date: Nov. 4, 2021

(54) Method and Apparatus for Processing Knowledge Graph

(71) Applicant: Beijing Gridsum Technology Co., Ltd., Beijing (CN)

(72) Inventor: Xuhong HAN, Beijing (CN)

(21) Appl. No.: 17/280,925

(22) PCT Filed: Jul. 30, 2019
(86) PCT No.: PCT/CN2019/098272

§ 371 Date: Mar. 29, 2021

(30) Foreign Application Priority Data
Sep. 30, 2018 (CN) 201811162047.2

(51) Int. Cl. G06F 16/28; G06N 5/02

(52) U.S. Cl. CPC G06F 16/288; G06N 5/02; G06F 16/285

(57) ABSTRACT

The disclosure discloses a method and apparatus for processing knowledge graph. The method includes that: multiple groups of entity data and multiple candidate relationship templates are acquired from a text to be analyzed, the candidate relationship template being configured to describe a relationship between multiple pieces of entity data in a group of entity data; for each group of entity data, the number of times for which the candidate relationship template matched with the group of entity data in the text to be analyzed is matched successfully is determined; a probability of correct matching between each group of entity data and each candidate relationship template is determined according to the number of times for which each group of entity data is matched successfully with each candidate relationship template; and an entity data relationship in a knowledge graph is supplemented according to the probability of correct matching between each group of entity data and the candidate relationship template.

### CROSS-REFERENCE TO RELATED APPLICATION

The present disclosure claims priority to Chinese Patent Application No. 201811162047.2, filed in the China National Intellectual Property Administration on Sep. 30, 2018, and entitled “Method and apparatus for processing knowledge graph”, the entire contents of which are incorporated herein by reference.

### TECHNICAL FIELD

The disclosure relates to the technical field of data processing, and particularly to a method and apparatus for processing knowledge graph.

### BACKGROUND

In a related art, a knowledge graph technology is a component of an artificial intelligence technology, and high semantic processing and interconnection organization capabilities thereof lay a foundation for intelligent information application. Meanwhile, with the technical development and application of artificial intelligence, knowledge graph, as one of key technologies, has been applied to the fields of intelligent search, intelligent question answering, personalized recommendation, content delivery and the like extensively. At present, a knowledge graph is constructed from the most original data (including structured data, semi-structured data and unstructured data) by extracting knowledge facts from an original database and a third-party database by use of a series of automatic or semiautomatic technical means and storing them to a data layer and mode layer of a knowledge base. There are mainly two knowledge graph construction methods at present. One is manual construction implemented by manually organizing structured data. The other is automatic construction implemented mainly by performing entity extraction on data through a Natural Language Processing (NLP) technology and then acquiring a relationship between entities by template matching or a classification model, thereby constructing a knowledge graph.

However, present knowledge graph construction is confronted with many problems. First of all, the manner of manually constructing a knowledge graph is time-consuming and labor-consuming, requires plenty of manpower and time and is unfavorable for long-term use. When a knowledge graph is constructed by use of a knowledge graph template, the accuracy is relatively low, and many noises may be made. In addition, if a knowledge graph is constructed through a classification model, a large number of manually labeled training corpora are required, namely the corpora are required to be manually labeled in advance, a lot of time is also required, a large number of human resources are occupied, and consequently, the efficiency of constructing the knowledge graph may be reduced.

For the problems, there is yet no effective solution.

### SUMMARY

According to an aspect of the embodiments of the disclosure, a method for processing knowledge graph is provided, which includes that: multiple groups of entity data and multiple candidate relationship templates are acquired from a text to be analyzed, the candidate relationship template being configured to describe a relationship between multiple pieces of entity data in a group of entity data; for each group of entity data, the number of times for which the candidate relationship template matched with the group of entity data in the text to be analyzed is matched successfully is determined; a probability of correct matching between each group of entity data and each candidate relationship template is determined according to the number of times for which each group of entity data is matched successfully with each candidate relationship template; and an entity data relationship in a knowledge graph is supplemented according to the probability of correct matching between each group of entity data and the candidate relationship template.

According to another aspect of the embodiments of the disclosure, an apparatus for processing knowledge graph is also provided, which includes: an acquisition unit, configured to acquire multiple groups of entity data and multiple candidate relationship templates from a text to be analyzed, the candidate relationship template being configured to describe a relationship between multiple pieces of entity data in a group of entity data; a first determination unit, configured to, for each group of entity data, determine the number of times for which the candidate relationship template matched with the group of entity data in the text to be analyzed is matched successfully; a second determination unit, configured to determine a probability of correct matching between each group of entity data and each candidate relationship template according to the number of times for which each group of entity data is matched successfully with each candidate relationship template; and a supplementing unit, configured to supplement an entity data relationship in a knowledge graph according to the probability of correct matching between each group of entity data and the candidate relationship template.

According to another aspect of the embodiments of the disclosure, a non-transitory storage medium is also provided, which is configured to store a program, wherein the program is executed by a processor to control a device where the non-transitory storage medium is located to execute any abovementioned method for processing knowledge graph.

According to another aspect of the embodiments of the disclosure, a processor is also provided, which is configured to run a program, wherein the program runs to execute any abovementioned method for processing knowledge graph.

### BRIEF DESCRIPTION OF THE DRAWINGS

The drawings described here are adopted to provide a further understanding to the disclosure and form a part of the disclosure. Schematic embodiments of the disclosure and descriptions thereof are adopted to explain the disclosure and not intended to form improper limits to the disclosure. In the drawings:

FIG. 1 is a flowchart of a method for processing knowledge graph according to an embodiment of the disclosure; and

FIG. 2 is a schematic diagram of another apparatus for processing knowledge graph according to an embodiment of the disclosure.

### DETAILED DESCRIPTION OF THE EMBODIMENTS

In order to make those skilled in the art understand the solutions of the disclosure better, the technical solutions in the embodiments of the disclosure will be clearly and completely described below in combination with the drawings in the embodiments of the disclosure. It is apparent that the described embodiments are not all embodiments but only a part of the embodiments of the disclosure. All other embodiments obtained by those of ordinary skill in the art based on the embodiments in the disclosure without creative work shall fall within the scope of protection of the disclosure.

It is to be noted that the terms like “first” and “second” in the specification, claims and accompanying drawings of the disclosure are used for differentiating the similar objects, but do not have to describe a specific order or a sequence. It is to be understood that data used like this may be exchanged under a proper condition for implementation of the embodiments of the disclosure described here in sequences besides those shown or described herein. In addition, terms “include” and “have” and any transformation thereof are intended to cover nonexclusive inclusions. For example, a process, method, system, product or device including a series of steps or units is not limited to those clearly listed steps or units, but may include other steps or units which are not clearly listed or inherent in the process, the method, the system, the product or the device.

For making it convenient for a user to understand the disclosure, part of terms or nouns involved in each embodiment of the disclosure will be explained below.

Knowledge graph, as a modern theory of combining theories and methods of disciplines such as applied mathematics, graphics, an information visualization technology and an information science and methods of metric citation analysis, co-occurrence analysis and the like to graphically present core structures, historical development, frontier fields and overall knowledge structures of the disciplines to achieve a multidisciplinary integration purpose by use of a visual graph, presents complex knowledge domains by data mining, information processing, knowledge measurement and graph drawing, reveals dynamic development rules of the knowledge domains and provides practical and valuable references for disciplinary researches.

In the related art, relationship extraction manners for a knowledge graph include the following three. The first is a supervised learning method: a relationship extraction task is considered as a classification problem, effective features are designed according to training data to learn various classification models, and then an entity relationship in the knowledge graph is predicted by use of a trained classifier. The second is a semi-supervised learning method: relationship extraction is performed by Bootstrapping, and for an entity relationship to be extracted, a plurality of seed instances are manually set and then a relationship template corresponding to the entity relationship is iteratively extracted from data. The third is an unsupervised learning method: namely there is made such a hypothesis that entity pairs with the same semantic relationship have similar context information, the semantic relationship of each entity pair is represented by the corresponding context information of the entity pair, and the semantic relationships of all the entity pairs are clustered.

In the relationship extraction manners for the knowledge graph, the supervised learning method is more advantageous in the aspect of achieving high accuracy and high recall rate because features may be extracted and utilized effectively, but the supervised learning method also has the defect that a large number of manually labeled training corpora are required while corpus labeling work is usually time-consuming and labor-consuming. For the semi-supervised and unsupervised methods, the relationship extraction accuracy is lower. There may be multiple corresponding relationships between different entity relationships, the same more context information may represent different relationships in different contexts or fields, and consequently, result extraction is not so ideal.

For the problems of the relationship extraction manners, the following embodiments of the disclosure may be applied to various knowledge graph construction solutions. A correlation matrix between relationship templates and entity data is constructed, whether the relationship templates are matched successfully with the entity data or not is sequenced, and the entity data corresponding to a relatively high matching success rate is further selected, or entity data extraction is performed on a new text through the relationship template with a relatively high matching success rate, and the entity data is further supplemented to a knowledge graph. In such a manner, the accuracy of establishing an entity data relationship in the knowledge graph is improved, and construction of the knowledge graph is completed. That is, in the following embodiments of the disclosure, unsupervised automatic entity relationship extraction may be implemented, thereby completing construction of the knowledge graph with relatively high accuracy. The disclosure will be described below in combination with each embodiment in detail.

### Embodiment 1

According to the embodiment of the disclosure, an embodiment of a method for processing knowledge graph is provided. It is to be noted that the steps presented in the flowchart of the drawings can be executed in a computer system like a set of computer executable instructions and, moreover, although a logical sequence is shown in the flowchart, in some cases, the presented or described steps can be executed in a sequence different from that described here.

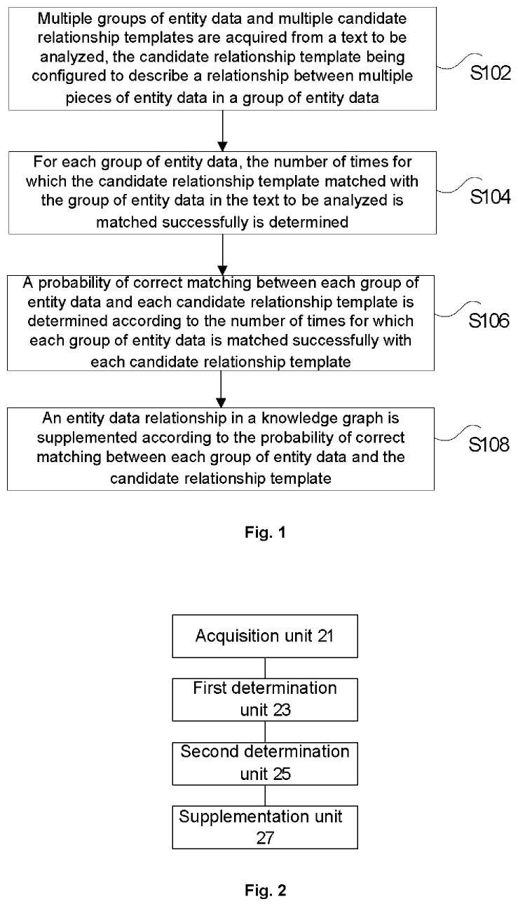

FIG. 1 is a flowchart of a method for processing knowledge graph according to an embodiment of the disclosure. As shown in FIG. 1, the method includes the following steps.

In S102, multiple groups of entity data and multiple candidate relationship templates are acquired from a text to be analyzed, the candidate relationship template being configured to describe a relationship between multiple pieces of entity data in a group of entity data.

In S104, for each group of entity data, the number of times for which the candidate relationship template matched with the group of entity data in the text to be analyzed is matched successfully is determined.

In S106, a probability of correct matching between each group of entity data and each candidate relationship template is determined according to the number of times for which each group of entity data is matched successfully with each candidate relationship template.

In S108, an entity data relationship in a knowledge graph is supplemented according to the probability of correct matching between each group of entity data and the candidate relationship template.

Through the steps, the multiple groups of entity data and the multiple candidate relationship templates may be acquired from the text to be analyzed, the candidate relationship template being configured to describe the relationship between the multiple pieces of entity data in a group of entity data; for each group of entity data, the number of times for which the candidate relationship template matched with the group of entity data in the text to be analyzed is matched successfully may be determined, the probability of correct matching between each group of entity data and each candidate relationship template may be determined according to the number of times for which each group of entity data is matched successfully with each candidate relationship template, and the entity data relationship in the knowledge graph may be supplemented according to the probability of correct matching between each group of entity data and the candidate relationship template. In the embodiment, the entity relationship may be supplemented by use of the relationship templates and the multiple groups of entity data, the entity relationship with relatively high accuracy is selected, and the knowledge graph is further supplemented by use of the selected entity relationship, so that the knowledge graph is optimized, and the technical problems in the related art that processing of the entity relationship of the knowledge graph consumes time and manpower and the construction efficiency of the knowledge graph is reduced are further solved.

Each step will be described below in detail.

In S102, the multiple groups of entity data and the multiple candidate relationship templates are acquired from the text to be analyzed, the candidate relationship template is configured to describe the relationship between the multiple pieces of entity data in a group of entity data.

In the exemplary embodiment, entity extraction of the text may be implemented, and the multiple candidate relationship templates may be acquired to implement statistics about the relationship templates.

The text to be analyzed may be a text required to be analyzed, and the text may include multiple statements.

The entity data may be data obtained by performing word extraction on each statement or a relationship description language. The entity data may be expressed as an entity pair. The extraction operation should be performed according to the corresponding relationship. For example, an entity relationship “China-Beijing” of “the Capital of China is Beijing” is extracted according to an entity data relationship “Capital”. The candidate relationship template may be a template expressing an entity data relationship corresponding to each statement, such as “the capital of ** is **”. In the step, when the multiple groups of entity data are acquired, related entity data of a corresponding entity class in the text may be extracted at first according to a present entity relationship. For entity data for which an entity class has been defined, multiple groups of entity data may be created. For example, in the relationship “Capital”, “China”-“Beijing”, “Japan”-“Tokyo” and “England”-“London” are entity pairs related to the relationship “Capital”.

In the embodiment of the disclosure, the operation that the multiple groups of entity data and the multiple candidate relationship templates are acquired includes that: a present entity relationship in the knowledge graph is acquired, a data class corresponding to the present entity relationship being defined as a target entity class; the multiple groups of entity data corresponding to the target entity class are extracted from statements of the text to be analyzed according to the present entity relationship; a predetermined semantic word is deleted from remaining words of each statement after extraction is completed, the predetermined semantic word at least including a stop word; and remaining words of each statement after deletion are combined to obtain the multiple candidate relationship templates.

The target entity class corresponds to the entity data relationship. For example, if the entity data relationship is expressed as “Capital”, extracted entity classes may be the country name and the city name. In the disclosure, the specific entity class is not limited and may be set according to each entity data relationship. Here, an entity word is acquired by crawling the web for words of a related entity type for matching. Optionally, a proper algorithm (for example, Conditional Random Field (CRF) and Hidden Markov Model (HMM)) may be selected for an entity type to be recognized, or the entity data may be acquired from person names, geographical names, organization names and the like in part-of-speech labeling by word matching.

In the implementation mode, the present entity relationship of the knowledge graph is acquired. The knowledge graph may be a knowledge graph that has been preliminarily established but the accuracy of the entity data extracted by the knowledge graph is low. After the entity data corresponding to the relatively high probability of correct matching between the entity data and the candidate relationship template is subsequently supplemented to the knowledge graph, the accuracy of correspondence between the entity data in the knowledge graph and the entity data relationship may be improved.

The present entity relationship may be a defined entity relationship, may be the following entity data relationship, and may also be an entity data relationship expressed in a similar manner.

Optionally, after the entity data of each statement is extracted, a candidate relationship template may be created for each statement. Here, the subsequent relationship template may be obtained by deleting the predetermined semantic word from the remaining words of each statement at first and then combining the remaining words. In an example, in a sentence “the Capital of China is Beijing”, after entity data “China-Beijing” is extracted, remaining words are “ the capital of ** is **”, and in such case, a candidate relationship template “capital-is” (corresponding to country-city) may be obtained by deleting a predetermined semantic word “of” and then combining remaining words.

The predetermined semantic word can be understood as a word insignificant for definition of the candidate relationship template, may be a stop word and may also be another word such as “of” and “is”.

In the exemplary embodiment, for avoiding the influence of part of sparse words, a word vector word2vec may be trained through a sampled domain text to perform similarity calculation on words in the candidate relationship template, and the word corresponding to a similarity value greater than a certain threshold is replaced for merging with a related candidate relationship template, to reduce relationship templates corresponding to close relationships and reduce the subsequent matching workload.

Through the abovementioned processing of the sparse words, the recall rate of the entity data may be increased, and the matching accuracy of the relationship template may also be improved.

In S104, for each group of entity data, the number of times for which the candidate relationship template matched with the group of entity data in the text to be analyzed is matched successfully is determined.

Determining the number of times for which the candidate relationship template matched with the group of entity data in the text to be analyzed is matched successfully may refer to extracting the multiple groups of entity data from the text to be analyzed, multiple pieces of entity data in the multiple groups of entity data may be the same, and in such case, the number of times for which multiple groups of entity data that are the same are matched successfully with a candidate relationship template may be obtained.

In the embodiment of the disclosure, when each group of entity data is matched with a candidate relationship template, there are two conditions that matching succeeds and matching fails. In the embodiment of the disclosure, a probability that matching succeeds may be determined according to a proportion of the number of times for which each group of entity data is matched successfully with the candidate relationship template in the total number of times.

In S106, the probability of correct matching between each group of entity data and each candidate relationship template is determined according to the number of times for which each group of entity data is matched successfully with each candidate relationship template.

In an optional example of the disclosure, the operation in S106 that the probability of correct matching between each group of entity data and each candidate relationship template is determined according to the number of times for which each group of entity data is matched successfully with each candidate relationship template includes that: a matrix is constructed, the matrix including each group of entity data, the candidate relationship template matched successfully with the group of entity data and the number of times for which, they are matched successfully; and the matrix is iterated through a preset sequencing algorithm to obtain the probability of correct matching between each group of entity data and each candidate relationship template.

For the matrix, the following matrix may be constructed:

$$\begin{matrix}\begin{matrix} \\ {pair}_{1} \\ ⋮ \\ {pair}_{k} \\ ⋮ \\ {pair}_{n}\end{matrix} & \begin{matrix}\begin{matrix}{patt}_{1} & … & {patt}_{r} & … & {patt}_{m}\end{matrix} \\ [ \begin{matrix}{count}_{11} & … & {count}_{1 r} & … & {count}_{1 m} \\ & ⋮ & & & \\ {count}_{k 1} & … & {count}_{kr} & … & {count}_{k m} \\ & ⋮ & & & \\ {count}_{n 1} & … & {count}_{nr} & … & {count}_{n m}\end{matrix} ]\end{matrix}\end{matrix} .$$

For the target matrix, pairₖ is the kth group of entity data (i.e., entity pair) that is extracted, pattᵣ is the rth candidate relationship template, and countₖᵣ represents the number of times for which pairₖ is matched with pattᵣ.

It is to be noted that the preset sequencing algorithm may be a bipartite graph sequencing algorithm. When the entity data is iterated through the bipartite graph sequencing algorithm, the following manner is adopted for iteration:

Pair_Probsₜ=Count_Matrix·Pattern_Probsₜ; 1

Pair_Prob′ₜ=norm(Pair_Probsₜ); 2

Pattern_Probsₜ₊₁=Count_Matrix^{T}·Pair_Probs′ₜ; 3

Pattern_Prob′ₜ₊₁=norm(Pair_Probsₜ₊₁); 4

where Pair_Probsₜ represents a probability matrix of the entity data in a t-th iteration, Pattern_Probsₜ represents a probability matrix of the candidate relationship template in the t-th iteration, Count_Matrix is target matrix, norm is a normalization operation, and

$$norm ( X ) = \frac{n}{{\sum }_{i = 1}^{n} {x}_{i}} \cdot X ,$$

where X is a matrix requiring normalization processing. Here, the denominator is multiplied by n to prevent the condition that part of values converge to 0 untimely and no effective convergence result can be obtained due to multiple iterative products caused by the fact that the sum is 1.

The iterative calculation is performed until a difference value between Pattern_Probsₜ and Pattern_Probsₜ₊₁ is less than a certain threshold, and then the probability of correct matching between each group of entity data and each candidate relationship template may be obtained.

In the embodiment of the disclosure, the operation that the probability of correct matching between each group of entity data and each candidate relationship template is determined includes that: a first total number of matches between each group of entity data and each candidate relationship template is acquired; a second total number of correct matches between each group of entity data and each candidate relationship template is determined; and the probability of correct matching between each group of entity data and each candidate relationship template is determined according to the second total number and the first total number.

The first total number indicates the number of the matches between the entity data and the candidate relationship templates, and the second total number indicates the number of the correct matches. In such a calculation manner, the probability value of correct matching between each group of entity data and each candidate relationship template may be obtained directly.

In S108, the entity data relationship in the knowledge graph is supplemented according to the probability of correct matching between each group of entity data and the candidate relationship template.

As an optional example of the disclosure, the operation that the entity data relationship in the knowledge graph is supplemented includes that: a probability value of correct matching between each group of entity data and each candidate relationship template is acquired; the entity data corresponding to the probability value greater than a preset probability threshold is selected; the selected entity data is determined as entity data to be supplemented; the entity data to be supplemented is supplemented to the knowledge graph; the template capable of matching an entity data relationship correctly in each candidate relationship template is defined as a target relationship template; and a target new text is extracted through the target relationship template, and extracted entity data is supplemented to the knowledge graph.

Through the implementation mode, the correctly matched entity data presently extracted from the text to be analyzed may be supplemented to the knowledge graph, or, of course, entity relationship extraction may be performed on the new text by use of the correctly matched relationship template to obtain new entity data and the entity data of the new text is further supplemented to the knowledge graph. In such a manner, a connection relationship of the knowledge graph about the entity data relationship is optimized, and the entity data is connected more closely.

In the embodiment of the disclosure, after the operation that the probability of correct matching between each group of entity data and the candidate relationship template is determined, the method further includes that: a matching probability value between each group of entity data and each candidate relationship template is acquired; the entity data corresponding to the matching probability value within a preset probability range is selected, and it is determined whether the entity data is target entity data or not according to a preset formula, the preset formula being

$${f}_{pair} = \frac{{\sum }_{r = 1}^{m} {count}_{kr} * IF ( {pattern\_prob}_{r} > threshold )}{{\sum }_{r = 1}^{m} {count}_{kr}} ,$$

where pattern_probᵣ is a ratio of the number of the templates capable of establishing correct entity data relationships in the candidate relationship templates to the total number of the templates, countₖᵣ the number of times for which the kth group of entity data is matched with the rth candidate relationship template, threshold is the preset probability range, the IF function is 1 when the condition is met, otherwise is 0, and when fₚₐᵢᵣ is greater than a target threshold, it indicates that present entity data is the target entity data; and the target entity data is supplemented to the knowledge graph.

The preset probability range may refer to a probability range where probability values are lower than a second probability threshold in the probability of correct matching between each group of entity data and the candidate relationship template. The entity data in the probability value is selected again, and the correct entity relationship is selected through the formula. The target entity data may refer to the correct entity relationship. The target entity data may be supplemented to the knowledge graph to complete the content of the knowledge graph.

Through the preset formula, low-frequency sparse entity data is recalled, and existence of correct entity data in the entity data corresponding to a relatively low probability value is determined.

Optionally, the IF function may refer to a relationship indicated by IF(pattern_{prob}_{ᵣ}>threshold) in the preset formula. A numerical value is returned through the IF function. In case of 1, the probability of correct matching between the entity data and the relationship template may be calculated. If the probability is greater than a third probability threshold, it indicates that a proportion of the template corresponding to the probability greater than the third probability threshold in the candidate relationship templates corresponding to the entity relationship is higher than a certain value. Therefore, it is determined that the presently matched entity data is the correct entity data.

In such a manner, entity data extraction may be performed on the new target text by use of the determined relationship template. Since the selected relationship template is a correct relationship template, relatively accurate entity data may be extracted from the new text, and the entity data may be supplemented to the knowledge graph to enrich the content of the knowledge graph. According to the embodiment of the disclosure, extraction of the entity data and construction of the relationship template may be implemented in an unsupervised learning manner without any, labeled corpus to automatically determine the entity data, so that manpower is saved. In addition, the accuracy of extracting the relationship template and the entity pair may also be improved to be higher than the accuracy of another unsupervised or semi-supervised method through the bipartite graph sequencing algorithm. Finally, in the embodiment of the disclosure, the recall rate of the sparse entity pair and the relationship template may be increased by word vector similarity calculation and sparse entity data supplementation.

The disclosure will be described below in combination with another optional apparatus embodiment.

### Embodiment 2

An apparatus for processing knowledge graph involved in the following embodiment may include multiple units, and each unit corresponds to each implementation step in embodiment 1.

FIG. 2 is a schematic diagram of another apparatus for processing knowledge graph according to an embodiment of the disclosure. As shown in FIG. 2, the apparatus includes an acquisition unit 21, a first determination unit 23, a second determination unit 25 and a supplementation unit 27.

The acquisition unit 21 is configured to acquire multiple groups of entity data and multiple candidate relationship templates from a text to be analyzed, the candidate relationship template being configured to describe a relationship between multiple pieces of entity data in a group of entity data.

The first determination unit 23 is configured to, for each group of entity data, determine the number of times for which the candidate relationship template matched with the group of entity data in the text to be analyzed is matched successfully.

The second determination unit 25 is configured to determine a probability of correct matching between each group of entity data and each candidate relationship template according to the number of times for which each group of entity data is matched successfully with each candidate relationship template.

The supplementation unit 27 is configured to supplement an entity data relationship in a knowledge graph according to the probability of correct matching between each group of entity data and the candidate relationship template.

Through the apparatus for processing knowledge graph, the multiple groups of entity data and the multiple candidate relationship templates may be acquired from the text to be analyzed through the acquisition unit 21, the candidate relationship template being configured to describe the relationship between the multiple pieces of entity data in a group of entity data; for each group of entity data, the number of times for which the candidate relationship template matched with the group of entity data in the text to be analyzed is matched successfully is determined through the first determination unit 23; the probability of correct matching between each group of entity data and each candidate relationship template is determined according to the number of times for which each group of entity data is matched successfully with each candidate relationship template through the second determination unit 25; and the entity data relationship in the knowledge graph is supplemented according to the probability of correct matching between each group of entity data and the candidate relationship template through the supplementation unit 27. In the embodiment, the entity relationship may be supplemented by use of the relationship templates and the multiple groups of entity data, the entity relationship with relatively high accuracy is selected, and the knowledge graph is further supplemented by use of the selected entity relationship, so that the knowledge graph is optimized, and the technical problems in the related art that processing of the entity relationship of the knowledge graph consumes time and manpower and the construction efficiency of the knowledge graph is reduced are further solved.

Optionally, the acquisition unit includes: a first acquisition module, configured to acquire a present entity relationship in the knowledge graph, a data class corresponding to the present entity relationship being defined as a target entity class; a first extraction module, configured to extract the multiple groups of entity data corresponding to the target entity class from statements of the text to be analyzed according to the present entity relationship; a deletion module, configured to delete a predetermined semantic word from remaining words of each statement after extraction is completed, the predetermined semantic word at least including a stop word; and a first combination module, configured to combine remaining words of each statement after deletion to obtain the multiple candidate relationship templates.

In an optional example of the disclosure, the second determination unit includes: a first construction module, configured to construct a matrix, the matrix including each group of entity data, the candidate relationship template matched successfully with the group of entity data and the number of times for which they are matched successfully; and an iteration module, configured to iterate the matrix through a preset sequencing algorithm to obtain the probability of correct matching between each group of entity data and each candidate relationship template.

Optionally, the preset sequencing algorithm is a bipartite graph sequencing algorithm.

In the embodiment of the disclosure, the second determination unit further includes: a second acquisition module, configured to acquire a first total number of matches between each group of entity data and each candidate relationship template; a first determination module, configured to determine a second total number of correct matches between each group of entity data and each candidate relationship template; and a second determination module, configured to determine the probability of correct matching between each group of entity data and each candidate relationship template according to the second total number and the first total number.

Optionally, the supplementing unit includes: a third acquisition module, configured to acquire a probability value of correct matching between each group of entity data and each candidate relationship template; a first selection module, configured to select the entity data corresponding to the probability value greater than a preset probability threshold; a third determination module, configured to determine the selected entity data as entity data to be supplemented; a first supplementing module, configured to supplement the entity data to be supplemented to the knowledge graph; a definition module, configured to define the template capable of matching an entity data relationship correctly in each candidate relationship template as a target relationship template; and an extraction module, configured to extract a target new text through the target relationship template and supplement extracted entity data to the knowledge graph.

As an optional example of the disclosure, the supplementing unit further includes: a fourth acquisition module, configured to acquire a matching probability value between each group of entity data and each candidate relationship template; a second selection module, configured to select the entity data corresponding to the matching probability value within a preset probability range and determine whether the entity data is target entity data or not according to a preset formula, the preset formula being

$${f}_{pair} = \frac{{\sum }_{r = 1}^{m} {count}_{kr} * IF ( {pattern\_prob}_{r} > threshold )}{{\sum }_{r = 1}^{m} {count}_{kr}} ,$$

where pattern_probᵣ is a ratio of the number of the templates capable of establishing correct entity data relationships in the candidate relationship templates to the total number of the templates, countₖᵣ is the number of times for which the kth group of entity data is matched with the rth candidate relationship template, threshold is the preset probability range, the IF function is 1 when the condition is met, otherwise is 0, and when fₚₐᵢᵣ is greater than a target threshold, it indicates that present entity data is the target entity data: and a second supplementing module, configured to supplement the target entity data to the knowledge graph.

The apparatus for processing knowledge graph may further include a processor and a memory. All the acquisition unit 21, the, first determination unit 23, the second determination unit 25, the supplementation unit 27 and the like are stored in the memory as program units, and the processor executes the program units stored in the memory to realize corresponding functions.

The processor includes a core, and the core calls the corresponding program unit in the memory. One or more cores may be arranged, and a core parameter is regulated to supplement the entity relationship of the knowledge graph.

The memory may include forms such as a nonvolatile memory, Random Access Memory (RAM) and/or nonvolatile memory in a computer-readable medium, for example, a Read-Only Memory (ROM) or a flash RAM, and the memory includes at least one storage chip.

According to another aspect of the embodiments of the disclosure, a storage medium is also provided, which is configured to store a program, wherein the program is executed by a processor to control a device where the storage medium is located to execute any abovementioned method for processing knowledge graph.

According to another aspect of the embodiments of the disclosure, a processor is also provided, which is configured to run a program, wherein the program runs to execute any abovementioned method for processing knowledge graph.

The embodiments of the disclosure provide a device, which includes a processor, a memory and a program stored in the memory and capable of running in the processor. The processor executes the program to execute the following steps: multiple groups of entity data and multiple candidate relationship templates are acquired from a text to be analyzed, the candidate relationship template being configured to describe a relationship between multiple pieces of entity data in a group of entity data; for each group of entity data, the number of times for which the candidate relationship template matched with the group of entity data in the text to be analyzed is matched successfully is determined; a probability of correct matching between each group of entity data and each candidate relationship template is determined according to the number of times for which each group of entity data is matched successfully with each candidate relationship template; and an entity data relationship in a knowledge graph is supplemented according to the probability of correct matching between each group of entity data and the candidate relationship template.

Optionally, the processor may execute the program to further implement the following steps: a present entity relationship in the knowledge graph is acquired, a data class corresponding to the present entity relationship being defined as a target entity class; the multiple groups of entity data corresponding to the target entity class are extracted from statements of the text to be analyzed according to the present entity relationship; a predetermined semantic word is deleted from remaining words of each statement after extraction is completed, the predetermined semantic word at least including a stop word; and remaining words of each statement after deletion are combined to obtain the multiple candidate relationship templates.

Optionally, the processor may execute the program to further implement the following steps: a matrix is constructed, the matrix including each group of entity data, the candidate relationship template matched successfully with the group of entity data and the number of times for which they are matched successfully; and the matrix is iterated through a preset sequencing algorithm to obtain the probability of correct matching between each group of entity data and each candidate relationship template.

Optionally, the preset sequencing algorithm is a bipartite graph sequencing algorithm.

Optionally, the processor may execute the program to further implement the following steps: a first total number of matches between each group of entity data and each candidate relationship template is acquired; a second total number of correct matches between each group of entity data and each candidate relationship template is determined; and the probability of correct matching between each group of entity data and each candidate relationship template is determined according to the second total number and the first total number.

Optionally, the processor may execute the program to further implement the following steps: a probability value of correct matching between each group of entity data and each candidate relationship template is acquired; the entity data corresponding to the probability value greater than a preset probability threshold is selected; the selected entity data is determined as entity data to be supplemented; the entity,data to be supplemented is supplemented to the, knowledge graph; the template capable of matching an entity data relationship correctly in each candidate relationship template is defined as a target relationship template; and a target new text, is extracted through the target relationship template, and extracted entity data is supplemented to the knowledge graph.

Optionally, the processor may execute the program to further implement the following steps; a matching probability value between each group of entity data and each candidate relationship template is acquired; the entity data corresponding to the matching probability value within a preset probability range is selected, and it is determined whether the entity data is target entity data or not according, to a preset formula, the preset formula being

$${f}_{pair} = \frac{{\sum }_{r = 1}^{m} {count}_{kr} * IF ( {pattern\_prob}_{r} > threshold )}{{\sum }_{r = 1}^{m} {count}_{kr}} ,$$

where pattern_probᵣ is a ratio of the number of the templates capable of establishing correct entity data relationships in the candidate relationship templates to the total number of the templates, countₖᵣ is the number of times for which the kth group of entity data is matched with the rth candidate relationship template, threshold is the preset probability range, the IF function is 1 when the condition is met, otherwise is 0, and when fₚₐᵢᵣ is greater than a target threshold, it indicates that present entity data is the target entity data; and the target entity data is supplemented to the knowledge graph.

The disclosure also provides a computer program product, which is suitable for executing a program initialized with the following method steps when executed in a data processing device: multiple groups of entity data and multiple candidate relationship templates are acquired from a text to be analyzed, the candidate relationship template being configured to describe a relationship between multiple pieces of entity data in a group of entity data; for each group of entity data, the number of times for which the candidate relationship template matched with the group of entity data in the text to be analyzed is matched successfully is determined; a probability of correct matching between each group of entity data and each candidate relationship template is determined according to the number of times for which each group of entity data is matched successfully with each candidate relationship template; and an entity data relationship in a knowledge graph is supplemented according to the probability of correct matching between each group of entity data and the candidate relationship template.

The sequence numbers of the embodiments of the disclosure are only adopted for description and do not represent superiority-inferiority of the embodiments.

In the embodiments of the disclosure, the descriptions of the embodiments focus on different aspects. The part which is not described in a certain embodiment in detail may refer to the related description of the other embodiments.

In some embodiments provided in the disclosure, it should be understood that the disclosed technical contents may be implemented in other manners. Herein, the device embodiment described above is only schematic. For example, division of the units is only division of logical functions, and other division manners may be adopted during practical implementation. For example, multiple units or components may be combined or integrated to another system, or some features may be ignored or are not executed. In addition, shown or discussed coupling, direct coupling or communication connection may be implemented through indirect coupling or communication connection of some interfaces, units or modules, and may be in an electrical form or other forms.

The units described as separate parts may or may not be separate physically, and parts displayed as units may or may not be physical units, that is, they may be located in the same place, or may also be distributed to multiple units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit. The integrated unit may be implemented in a hardware form and may also be implemented in form of software functional unit.

If being implemented in form of software functional unit and sold or used as an independent product, the integrated unit may be stored in a computer-readable storage medium. Based on such an understanding, the technical solutions of the disclosure substantially or parts making contributions to the conventional art or all or part of the technical solutions may be embodied in form of software product. The computer software product is stored in a storage medium, including a plurality of instructions configured to enable a computer device (which may be a PC, a server, a network device or the like) to execute all or part of the steps of the method in each embodiment of the disclosure. The storage medium includes various media capable of storing program codes such as a U disk, a ROM, a RAM, a mobile hard disk, a magnetic disk or a compact disc.

The above is only the preferred embodiment of the disclosure. It is to be pointed out that those of ordinary skill in the art may also make a number of improvements and embellishments without departing from the principle of the disclosure and these improvements and embellishments shall also fall within the scope of protection of the disclosure.

### Industrial Applicability

The solutions provided in the embodiments of the disclosure may be applied to supplementation of an entity data relationship in a knowledge graph in artificial intelligence. The technical solutions provided in the embodiments of the disclosure may be applied to various knowledge graph construction and utilization solutions for artificial intelligence. Entity relationships are supplemented by use of relationship templates and multiple groups of entity data, the entity relationship with relatively high accuracy is selected, and the selected entity relationship is further adopted to supplement the knowledge graph to optimize the knowledge graph. In such a control manner, the technical problems in the related art that processing of the entity relationship of the knowledge graph consumes time and manpower and the construction efficiency of the knowledge graph is reduced may be solved, the utilization rate of the knowledge graph may be increased, and more intelligent control requirements may be met.

What is claimed:

1. A method for processing knowledge graph, comprising:
acquiring multiple groups of entity data and multiple candidate relationship templates from a text to be analyzed, the candidate relationship template being configured to describe a relationship between multiple pieces of entity data in a group of entity data;
for each group of entity data, determining the number of times for which the candidate relationship template matched with the group of entity data in the text to be analyzed is matched successfully;
determining a probability of correct matching between each group of entity data and each candidate relationship template according to the number of times for which each group of entity data is matched successfully with each candidate relationship template; and
supplementing an entity data relationship in a knowledge graph according to the probability of correct matching between each group of entity data and the candidate relationship template.

2. The method as claimed in claim 1, wherein acquiring the multiple groups of entity data and the multiple candidate relationship templates comprises:
acquiring a present entity relationship in the knowledge graph, a data class corresponding to the present entity relationship is defined as a target entity class;
extracting the multiple groups of entity data corresponding to the target entity class from statements of the text to be analyzed according to the present entity relationship;
deleting a predetermined semantic word from remaining words of each statement after extraction is completed, the predetermined semantic word at least comprising a stop word; and
combining remaining words of each statement after deletion to obtain the multiple candidate relationship templates.

3. The method as claimed in claim 1, wherein determining the probability of correct matching between each group of entity data and each candidate relationship template according to the number of times for which each group of entity data is matched successfully with each candidate relationship template comprises:
constructing a matrix, the matrix comprising each group of entity data, the candidate relationship template matched successfully with the group of entity data and the number of times for which they are matched successfully; and
iterating the matrix through a preset sequencing algorithm to obtain the probability of correct matching between each group of entity data and each candidate relationship template.

4. The method as claimed in claim 3, wherein the preset sequencing algorithm is a bipartite graph sequencing algorithm.

5. The method as claimed in claim 1, wherein determining the probability of correct matching between each group of entity data and each candidate relationship template comprises:
acquiring a first total number of matches between each group of entity data and each candidate relationship template;
determining a second total number of correct matches between each group of entity data and each candidate relationship template; and
determining the probability of correct matching between each group of entity data and each candidate relationship template according to the second total number and the first total number.

6. The method as claimed in claim 5, wherein supplementing the entity data relationship in the knowledge graph comprises:
acquiring a probability value of correct matching between each group of entity data and each candidate relationship template;
selecting the entity data corresponding to the probability value greater than a preset probability threshold;
determining the selected entity data as entity data to be supplemented;
supplementing the entity data to be supplemented to the knowledge graph;
defining the template capable of matching an entity data relationship correctly in each candidate relationship template as a target relationship template; and
extracting a target new text through the target relationship template, and supplementing extracted entity data to the knowledge graph.

7. The method as claimed in claim 1, wherein supplementing the entity data relationship in the knowledge graph further comprises:
acquiring a matching probability value between each group of entity data and each candidate relationship template; selecting the entity data corresponding to the matching probability value within a preset probability range, and determining whether the entity data is target entity data or not according to a preset formula, the preset formula being:
$${f}_{pair} = \frac{{\sum }_{r = 1}^{m} {count}_{kr} * IF ( {pattern\_prob}_{r} > threshold )}{{\sum }_{r = 1}^{m} {count}_{kr}} ,$$
where pattern_probᵣ is a ratio of the number of the templates capable of establishing correct entity data relationships in the candidate relationship templates to the total number of the templates, countₖᵣ is the number of times for which the kth group of entity data is matched with the rth candidate relationship template, threshold is the preset probability range, the IF function is 1 when the condition is met, otherwise is 0, and when fₚₐᵢᵣ is greater than a target threshold, present entity data is the target entity data; and
supplementing the target entity data to the knowledge graph.

8. An apparatus for processing knowledge graph, comprising:
an acquisition unit, configured to acquire multiple groups of entity data and multiple candidate relationship templates from a text to be analyzed, the candidate relationship template being configured to describe a relationship between multiple pieces of entity data in a group of entity data;
a first determination unit, configured to, for each group of entity data, determine the number of times for which the candidate relationship template matched with the group of entity data in the text to be analyzed is matched successfully;
a second determination unit, configured to determine a probability of correct matching between each group of entity data and each candidate relationship template according to the number of times for which each group of entity data is matched successfully with each candidate relationship template; and
a supplementing unit, configured to supplement an entity data relationship in a knowledge graph according to the probability of correct matching between each group of entity data and the candidate relationship template.

9. A non-transitory storage medium, configured to store a program, wherein the program is executed by a processor to control a device where the non-transitory storage medium is located to execute the method for processing knowledge graph as claimed in claims 1.

10. (canceled)

11. The method as claimed in claim 7, wherein the preset probability range refers to a probability range where probability values are lower than a second probability threshold in the probability of correct matching between each group of entity data and the candidate relationship template.

12. The method as claimed in claim 7, wherein the entity data is data obtained by performing word extraction on each statement or a relationship description language.
